(19) United States
(12) Patent Application Publication
(10) Pub. No.: US 2008/0216344 A1
(43) Pub. Date: Sep. 11, 2008

(54) Drying Apparatus

(75) Inventors: John Churchill, Gloucestershire (GB); Frederic Nicolas, Wiltshire (GB)

Correspondence Address: MORRISON & FOERSTER LLP, 1650 TYSONS BOULEVARD, SUITE 400, MCLEAN, VA, 22102, US

(73) Assignee: Dyson Technology Limited, Malmesbury, WILTSHIRE (GB)

(21) Appl. No.: 11/997,311

(22) PCT Filed: Jun. 13, 2006
(86) PCT No.: PCT/GB06/02135

§ 371 Date: Jan. 29, 2008

(30) Foreign Application Priority Data
Jul. 30, 2005 (GB) 0515741.7

(51) Int. Cl. A47K 10/48; A47K 10/00; F26B 19/00

(52) U.S. Cl. 34/202

(57) ABSTRACT

A drying apparatus has a casing, a cavity formed in the casing for receiving an object, a fan located in the casing and creating an airflow, and at least one slot-like opening communicating with the fan and arranged in the casing so as to direct an airflow transversely across the cavity. The slot-like opening is formed between opposing walls so that one of the walls terminates substantially flush with the casing and the other wall protrudes beyond the casing. The slot-like opening may be formed between an upper wall and a lower wall, the lower wall may terminate substantially flush with the casing and the upper wall protrudes beyond the casing, reducing the effect of the air causing the user's hands to be pulled or sucked towards the slot-like openings but eliminating any protrusion of the walls of the slot-like opening on one side.

### REFERENCE TO RELATED APPLICATIONS

This application is a national stage application under 35 USC 371 of International Application No. PCT/GB2006/002135, filed Jun. 12, 2006, which claims the priority of United Kingdom Application No. 0515741.7, filed Jul. 30, 2005, the contents of both of which prior applications are incorporated herein by reference.

### FIELD OF THE INVENTION

The invention relates to drying apparatus which makes use of a narrow jet of high velocity, high pressure air to dry an object, including part of the human body. Particularly, but not exclusively, the invention relates to a hand dryer in which the air jet is emitted through a slot-like opening in the casing of the hand dryer.

### BACKGROUND OF THE INVENTION

The use of air jets to dry hands is well known. Examples of hand dryers which emit at least one air jet through a slot-like opening are shown in GB 2249026A, JP 2002-034835A and JP 2002306370A. The walls of the slot-like openings shown in some of these prior art documents project beyond the walls of the casings in which the slot-like openings are formed. This reduces the likelihood of the user's hands being sucked towards the wall of the casing while the hand dryer is in use. However, the protrusion of the walls of the slot-like openings also presents a hazard in that the user's hands may be scratched on the walls, or articles such as watches, bracelets and the like may become caught or snagged thereon.

### SUMMARY OF THE INVENTION

It is an object of the invention to provide drying apparatus which, in use, is comfortable for the user to use and which reduces or eliminates any risk of objects becoming caught or snagged during use.

The invention provides drying apparatus having a casing, a cavity formed in the casing for receiving an object, a fan located in the casing and capable of creating an airflow, and at least one slot-like opening communicating with the fan and arranged in the casing so as to direct an airflow transversely across the cavity, the slot-like opening being formed between opposing walls, wherein one of the walls terminates substantially flush with the casing and the other wall protrudes beyond the casing.

Preferably, the slot-like opening is formed between an upper wall and a lower wall and, more preferably, the lower wall terminates substantially flush with the casing and the upper wall protrudes beyond the casing.

This arrangement has been found still to reduce the effect of the air causing the user's hands to be pulled or sucked towards the slot-like openings but has the added advantage of eliminating any protrusion of the walls of the slot-like opening on one side thereof. It is particularly useful to eliminate the protrusion of the walls on the lower side of the slot-like opening as this helps to avoid clothing, watches, bracelets and the like becoming caught or snagged on what would otherwise be an overhanging lip as the hands are withdrawn from the cavity.

In a preferred embodiment, the upper wall protrudes beyond the casing to a distance of substantially 5 mm. This distance has been found to be sufficient to avoid the user's hands being pulled towards the slot-like openings when only one wall protrudes beyond the casing.

### BRIEF DESCRIPTION OF THE DRAWINGS

An embodiment of the invention in the form of a hand dryer will now be described with reference to the accompanying drawings, in which:

FIG. 1 is a side view of a hand dryer according to the invention;

FIG. 2 is a perspective view of the hand dryer of FIG. 1;

FIG. 3 is a side sectional view of the hand dryer of FIG. 1;

FIG. 4 is a side sectional view, shown on an enlarged scale, of the upper ends of the air ducts forming part of the hand dryer of FIG. 1;

FIG. 5 is a schematic sectional side view, shown on a further enlarged scale, of the slot-like opening located in the front wall of the cavity of the hand dryer of FIG. 1; and;

FIG. 6 is a schematic sectional side view, shown on the same further enlarged scale, of the slot-like opening located in the rear wall of the cavity of the hand dryer of FIG. 1.

### DETAILED DESCRIPTION OF THE INVENTION

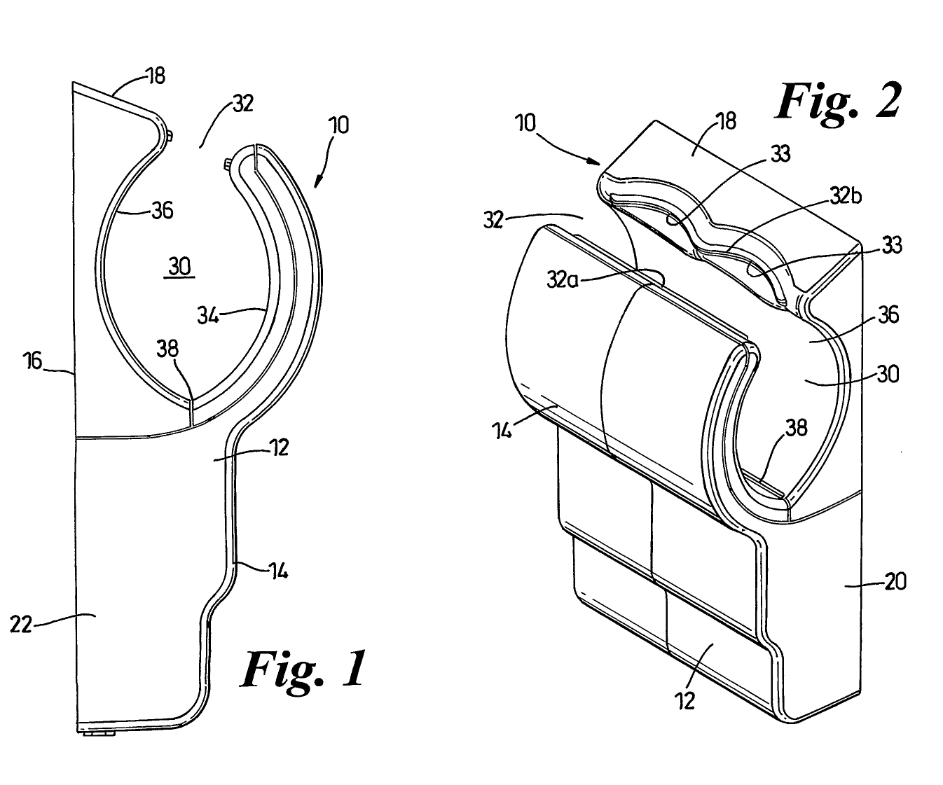

Referring firstly to FIGS. 1 and 2, the hand dryer 10 shown in the drawings comprises an outer casing 12 having a front wall 14, a rear wall 16, an upper face 18 and side walls 20, 22. The rear wall 16 can incorporate fixing devices (not shown) for securing the hand dryer 10 to a wall or other structure prior to use. An electrical connection (not shown) is also provided on the rear wall or elsewhere on the casing 12. A cavity 30 is formed in the upper part of the casing 12 as can be seen from FIGS. 1 and 2. The cavity 30 is open at its upper end and delimited thereat by the top of the front wall 14 and the front of the upper face 18. The space between the top of the front wall 14 and the front of the upper face 18 forms a cavity entrance 32 which is sufficiently wide to allow a user's hands to be introduced to the cavity 30 through the cavity entrance 32. The cavity 30 is also open to the sides of the hand dryer 10 by appropriate shaping of the side walls 20, 22.

The cavity 30 has a front wall 34 and a rear wall 36 which delimit the cavity 30 to the front and rear respectively. Located in the lowermost end of the cavity 30 is a drain 38 which communicates with a reservoir (not shown) located in the lower part of the casing 12. The purpose of the drain and reservoir will be described below.

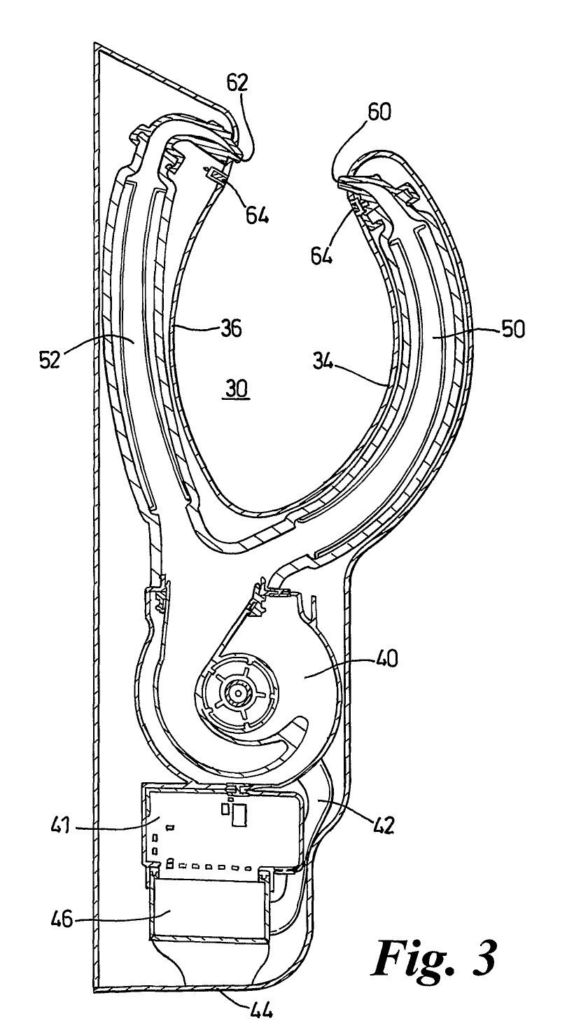

As shown in FIG. 3, a motor (not shown) is located inside the casing 12 and a fan 40, which is driven by the motor, is also located inside the casing 12. The motor is connected to the electrical connection and is controlled by a controller 41. The inlet 42 of the fan 40 communicates with an air inlet 44 formed in the casing 12. A filter 46 is located in the air passageway connecting the air inlet 44 to the fan inlet 42 so as to prevent the ingress of any debris which might cause damage to the motor or the fan 40. The outlet of the fan 40 communicates with a pair of air ducts 50, 52 which are located inside the casing 12. The front air duct 50 is located primarily between the front wall 14 of the casing 12 and the front wall 34 of the cavity 30, and the rear air duct 52 is located primarily between the rear wall 16 of the casing 12 and the rear wall 36 of the cavity 30.

The air ducts 50, 52 are arranged to conduct air from the fan 40 to a pair of opposed slot-like openings 60, 62 which are located in the front and rear walls 34, 36 respectively of the cavity 30. The slot-like openings 60, 62 are arranged at the upper end of the cavity 30 in the vicinity of the cavity entrance 32. The slot-like openings 60, 62 are each configured so as to direct an airflow generally across the cavity entrance 32 towards the opposite wall of the cavity 30. The slot-like openings 60, 62 are offset in the vertical direction and angled towards the lowermost end of the cavity 30.

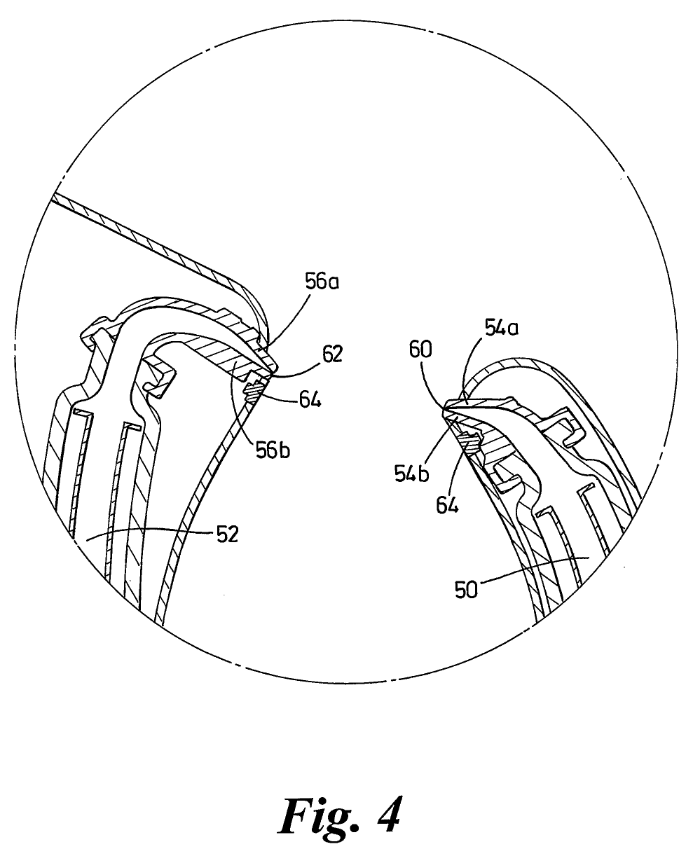

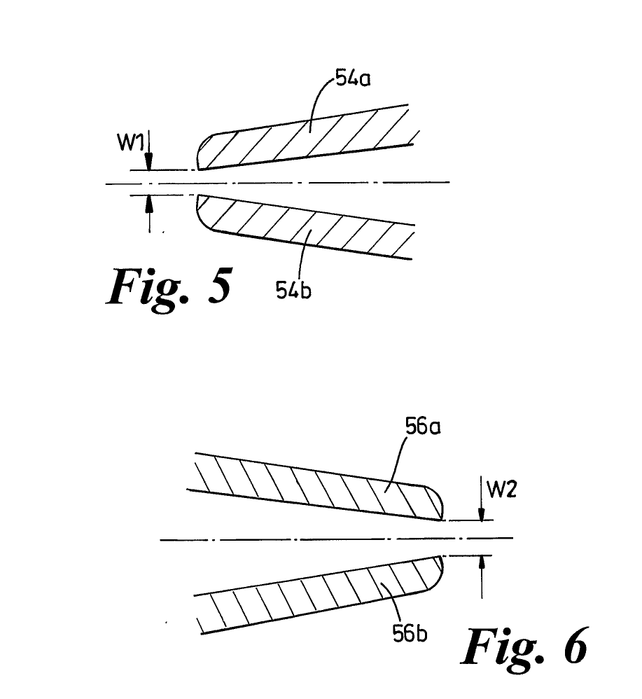

FIG. 4 shows the upper ends of the air ducts 50, 52 and the slot-like openings 60, 62 in greater detail. As can be seen, the walls 54a, 54b of the air duct 50 converge to form the slot-like opening 60 and the walls 56a, 56b of the air duct 52 converge to form the slot-like opening 62. Even greater detail can be seen in FIGS. 5 and 6. FIG. 5 shows that the slot-like opening 60 has a width of W1 and FIG. 6 shows that the slot-like opening 62 has a width of W2. The width W1 of the slot-like opening 60 is smaller than the width W2 of the slot-like opening 62. The width W1 is 0.3 mm and the width W2 is 0.4 mm.

Sensors 64 are positioned in the front and rear walls 34, 36 of the cavity 30 immediately below the slot-like openings 60, 62. These sensors 64 detect the presence of a user's hands which are inserted into the cavity 30 via the cavity entrance 32 and are arranged to send a signal to the motor when a user's hands are introduced to the cavity 30.

As can be seen from FIGS. 3 and 4, the upper walls 54a, 56a of the ducts 50, 52 project slightly beyond the surface of the front and rear walls 34, 36 of the cavity 30 whilst the lower walls 54b, 56b terminate substantially flush with the front and rear walls 34, 36 of the cavity 30. The distance by which the upper walls 54a, 56a project is selected to be substantially 5 mm. The inward projection of the upper walls 54a, 56a of the ducts 50, 52 reduces the tendency of the user's hands to be sucked towards one or other of the walls 34, 36 of the cavity, which enhances the ease with which the hand dryer 10 can be used. However, the elimination of any protrusion of the lower walls 54b, 56b beyond the front and rear walls 34, 36 means that a smooth surface is presented below the slot-like openings 60, 62.

As can be seen from FIG. 2, the shape of the cavity entrance 32 is such that the front edge 32a is generally straight and extends laterally across the width of the hand dryer 10. However, the rear edge 32b has a shape which consists of two curved portions 33 which generally follow the shape of the backs of a pair of human hands as they are inserted downwardly into the cavity 30 through the cavity entrance 32. The rear edge 32b of the cavity entrance 32 is substantially symmetrical about the centre line of the hand dryer 10. The intention of the shaping and dimensioning of the front and rear edges 32a, 32b of the cavity entrance 32 is that, when a user's hands are inserted into the cavity 30 through the cavity entrance 32, the distance from any point on the user's hands to the nearest slot-like opening is substantially uniform.

The hand dryer 10 described above operates in the following manner. When a user's hands are first inserted into the cavity 30 through the cavity entrance 32, the sensors 64 detect the presence of the user's hands and send a signal to the motor to drive the fan 40. The fan 40 is thus activated and air is drawn into the hand dryer 10 via the air inlet 44 at a rate of approximately 20 to 40 litres per second and preferably at a rate of least 25 to 27 litres per second, more preferably air is drawn into the hand dryer 10 at a rate of 31 to 35 litres per second. The air passes through the filter 46 and along the fan inlet 42 to the fan 40. The airflow leaving the fan 40 is divided into two separate airflows; one passing along the front air duct 50 to the slot-like opening 60 and the other passing along the rear air duct 52 to the slot-like opening 62.

The airflow is ejected from the slot-like openings 60, 62 in the form of very thin, stratified sheets of high velocity, high pressure air. As the airflows leave the slot-like openings 60, 62, the air pressure is at least 15 kPa and preferably approximately 20 to 23 kPa. Furthermore, the speed of the airflow leaving the slot-like openings 60, 62 is at least 80 m/s and preferably at least 100 or 150 m/s, more preferably approximately 180 m/s. Because the size of the slot-like opening 62 located at the end of the rear duct 52 is greater than the size of the slot-like opening 60 located at the end of the front duct 50, a larger volume of air is emitted from the duct 52 than from the duct 50. This provides a greater mass of air for drying the backs of the user's hands which is advantageous.

The two thin sheets of stratified, high velocity, high pressure air are directed towards the surfaces of the user's hands which, during use, are inserted fully into the cavity 30 and are subsequently withdrawn from the cavity 30 via the cavity entrance 32. As the user's hands pass into and out of the cavity 30, the sheets of air blow any existing water off the user's hands. This is achieved reliably and effectively because of the high momentum of the air leaving the slot-like openings 60, 62 and because the airflow is evenly distributed along the length of each slot-like opening 60, 62.

The protrusion of the upper walls 54a, 56a beyond the front and rear walls 34, 36 of the cavity reduces the risk of the user's hands being sucked towards either of the slot-like openings 60, 62 which provides more comfort for the user. As the user's hands are withdrawn from the cavity, a smooth surface is presented to the hands which does not include any overhanging or sharp projections. Thus, even if the user's hands are inadvertently drawn or moved towards the slot-like openings, there is no risk of the user's hands becoming scratched or grazed, nor of any items such as clothing, watches or bracelets becoming caught or snagged on the slot-like openings.

Each stratified sheet of air is directed towards the wall of the cavity 30 which is remote from the slot-like opening through which the respective sheet of air is emitted. Because the slot-like openings 60, 62 are also inclined towards the lowermost end of the cavity 30, the emitted airflows are directed into the cavity 30. This reduces the risk of turbulent air movement being felt by the user outside the casing, eg in the user's face.

It is envisaged that it will take only a small number of “passes” of the hand dryer described above to dry a user's hands to a satisfactory degree. (By “pass”, we mean a single insertion of the hands into the cavity and subsequent removal therefrom at a speed which is not unacceptable to an average user. We envisage that a single pass will have a duration of no more than 3 seconds.) The momentum achieved by the airflows is sufficient to remove the majority of water found on the surface of the user's hands after washing during a single pass.

The water removed by the airflows is collected inside the cavity 30. Each airflow will rapidly lose its momentum once it has passed the user's hands and the water droplets will fall to the lower end of the cavity 30 under the forces of gravity whilst the air exits the cavity 30 either through the cavity entrance 32 or via the open sides of the cavity 30. The water, however, is collected by the drain 38 and passed to a reservoir (not shown) where it is collected for disposal. The reservoir can be emptied manually if desired. Alternatively, the hand dryer 10 can incorporate some form of water dispersal system including, for example, a heater for evaporating the collected water into the atmosphere. The means by which the collected water is dispersed does not form part of the present invention.

In an alternative embodiment, the slot-like openings 60a, 62a can be arranged so that the sheets of air which are emitted therefrom are directed generally along planes which are substantially parallel to one another. This minimises the amount of turbulent flow present inside the cavity 30 whilst the drying apparatus is in use.

The invention is not intended to be limited to the precise detail of the embodiment described above. Modifications and variations to the detail which do not alter the scope of the invention will be apparent to a skilled reader. For example, the shape of the cavity 30 and its entrance 32 may be altered without departing from the essence of the present invention.

1. A drying apparatus, comprising a casing, a cavity formed in the casing for receiving an object, a fan located in the casing and creating an airflow, and at least one slot-like opening communicating with the fan and arranged in the casing to direct an airflow transversely across the cavity, the slot-like opening being formed between opposing walls, wherein one of the walls terminates substantially flush with the casing and the other wall protrudes beyond the casing.

2. The drying apparatus as claimed in claim 1, wherein the slot-like opening is formed between an upper wall and a lower wall.

3. The drying apparatus as claimed in claim 2, wherein the lower wall terminates substantially flush with the casing and the upper wall protrudes beyond the casing.

4. The drying apparatus as claimed in claim 3, wherein the upper wall protrudes beyond the casing to a distance of about 5 mm.

5. The drying apparatus as claimed in claim 1 or 2, wherein the velocity of the airflow emitted through the slot-like opening is at least 80 m/s.

6. The drying apparatus as claimed in claim 5, wherein the velocity of the airflow emitted through the slot-like opening is at least 100 m/s.

7. The drying apparatus as claimed in claim 1 or 2, wherein the pressure of the airflow emitted through the slot-like opening is at least 15 kPa.

8. The drying apparatus as claimed in claim 7, wherein the pressure of the airflow emitted through the slot-like opening is at least 20 kPa.

9. The drying apparatus as claimed in claim 1 or 2, wherein two opposed slot-like openings are provided, one slot-like opening being provided on each of front and rear walls of the cavity.

10. The drying apparatus as claimed in claim 1 or 2, wherein the drying apparatus is a hand dryer.

11. (canceled)
